(19) United States
(12) Patent Application Publication
(10) Pub. No.: US 2008/0121489 A1
(43) Pub. Date: May 29, 2008

(54) Centrifugal Clutch and Actuator

(76) Inventor: John Phillip Chevalier, London (GB)

Correspondence Address: DICKSTEIN SHAPIRO LLP, 1825 EYE STREET NW, Washington, DC, 20006-5403, US

(21) Appl. No.: 11/885,759

(22) PCT Filed: Feb. 9, 2006
(86) PCT No.: PCT/GB06/00455

§ 371 Date: Sep. 6, 2007

(30) Foreign Application Priority Data
Mar. 7, 2005 (GB) 0504676.8

(51) Int. Cl. F16D 43/16; F16D 43/21; F16D 3/68; F16D 3/72; G05B 11/01

(52) U.S. Cl. 192/105 BB; 477/14; 477/34; 700/13

(57) ABSTRACT

A centrifugal clutch for coupling a drive shaft to a driven member at rotary speeds above a predetermined threshold, comprising: a centrifugal slider (302) with a massive enlargement (320) at one end and a first coupling formation; a frame (301) formed to carry the centrifugal slider on formations to constrain it to sliding motion between an extended radial position and a retracted radial position, and to fit fixedly on the drive shaft to be driven by it, with the shaft at right-angles to the axis of sliding motion of the frame, whereby the frame (301) and the slider (302) cooperate to constitute a flywheel (3) on the drive shaft axis and the centre of inertia of the centrifugal clutch is axial only when the centrifugal slider is at its extended radial position, whereby its rotation is fully balanced when the clutch is engaged.

This invention relates to a centrifugal clutch, that is to an over-running clutch, and to an actuator including a centrifugal clutch. The invention also relates to a drive system for moving a load subject to static and dynamic frictional drag, and to a method of driving a load. The invention is particularly, although not exclusively, useful for the actuation of automotive seats, sun roofs, windows, steering locks, windscreen wipers, automated manual transmissions, seat adjustors, electronic parking brakes and seat belt pretensioners, engine starter motors, braking systems and automatic gear boxes; in short, any drive mechanism designed for moving inertial mass and keeping it in controlled motion. In principle, the invention is applicable to any drive system, rotational or linear, in which a load has to be moved against frictional drag, the invention being particularly useful in overcoming static friction. It finds application in diverse fields such as elevators and retail point of sale conveyors.

Many functions within cars are now electrically operated, such as the vehicle seats, sunroofs, windows, steering column locks, windscreen wipers, automated manual transmissions (semi-automated transmissions), seat adjustors, electronic parking brakes, seat belt pretensioners and starter motors. Many of these functions require a large driving force or torque, and engineers have generally developed high power electric motors to provide the necessary output. The disadvantage of this approach is that such electric motors are large, heavy and expensive, requiring a high power input from the car battery or alternator.

Accordingly, the purpose of the present invention is to overcome or mitigate these disadvantages of the presently-available actuators. There is an increasing pressure to reduce vehicle weight, power consumption and cost , thereby improving vehicle performance and economy and reducing the damage done to the environment.

Accordingly, the invention provides a centrifugal clutch for coupling a drive shaft to a driven member at rotary speeds above a predetermined threshold, comprising: a centrifugal slider with a massive enlargement at one end and a first coupling formation; a frame formed to carry the centrifugal slider on formations to constrain it to sliding motion between an extended radial position and a retracted radial position, and to fit fixedly on the drive shaft to be driven by it, with the shaft at right-angles to the axis of sliding motion of the frame; an output drive member mountable for free rotation on the drive shaft and formed for driving engagement with the driven member in use, and formed with a second coupling formation which connects drivingly with the first only when the centrifugal slider is at its extended position; and means for biasing the centrifugal slider towards its retracted position; whereby rotation of the centrifugal slider and frame causes the massive enlargement to pull the centrifugal slider radially from its retracted to its extended radial position to cause the first and second coupling arrangements to interengage and thus to transmit rotary drive from the drive shaft to the driven member, but the biasing means causes disengagement when the rotation ceases, so as to decouple the drive shaft from the driven member; characterized in that the frame and the slider cooperate to constitute a flywheel on the drive shaft axis and the centre of inertia of the centrifugal clutch is axial only when the centrifugal slider is at its extended radial position, whereby its rotation is fully balanced when the clutch is engaged.

This centrifugal clutch can incorporate the features disclosed in my patent application GB-A-2392958 entitled “A Pre-assembled Centrifugal Clutch”. The moment of inertia of the flywheel, the predetermined rotational speed at which the centrifugal clutch engages, the power, acceleration and maximum speed of the motor, are all selectable, in the design of the centrifugal clutch to suit any given application, to meet the demands of static and dynamic frictional drag, and the specific lifting or other load requirements. For example, in its application to a car window actuator, the rating of the electric motor, and the ratio of the reduction gearing, together with the speed at which the centrifugal clutch engages, are designed to give the actuator sufficient “kick” upon engagement to overcome static friction in the window frame, in normal use, and to provide continued lift for the window, overcoming dynamic friction as the window is raised.

Further the invention provides a centrifugal clutch for coupling a drive shaft to a driven member at rotary speeds above a predetermined threshold, comprising: a frame and a centrifugal slider cooperating to constitute a flywheel on the drive shaft axis; and a coupling member for driving the driven member in use; in which the flywheel is coupled rotationally to drive the coupling member such that limited relative rotational movement is allowed between them.

The invention also provides an actuator comprising an electric motor drivingly coupled to an output coupling gear by way of a centrifugal clutch, the centrifugal clutch having centrifugally-coupled driving and driven members, further comprising a flywheel drivingly coupled between the electric motor and the driven member of the centrifugal clutch, for accumulating rotational inertia during acceleration to the speed at which the centrifugal clutch engages the electric motor with the output coupling gear.

The flywheel may be integral with the input member of the centrifugal clutch. The centrifugal clutch may be in accordance with the first definition of the invention above, the frame and the slider constituting the said flywheel.

For some applications of the invention, the output drive member has a coupling member for driving engagement with the driven member in use, and the second coupling formation is coupled rotationally to drive the coupling member such that limited relative rotational movement is allowed between them.

To provide slippage when there is excess torque, the coupling member may be coupled to the second coupling formation by frictional engagement so that their rotational driving coupling slips above a predetermined applied torque.

Instead of a frictional coupling the coupling member may be coupled resiliently to the second coupling formation so that an applied torque causes proportionate relative rotational movement which is then released by spring action when the applied torque is reduced. Preferably then the output drive member comprises a torsion spring connecting the coupling member drivingly with the second coupling formation.

This resilient coupling then stores potential energy immediately following the engagement of the clutch, to spread over a period of time the impulsive transfer of inertia to the load—this may be adjusted to suite the requirements of the load, which will have particular static and dynamic friction characteristics. A starter motor for example has to drive a vehicle engine as a load which has heavy friction at low speeds during its initial acceleration.

Depending on the parameters of the kick-drive mechanism, the impact torque released at the point of impact can be considerably higher than the force needed safely to move the inertial mass of the driven system. An example of such an arrangement is in the use of the kick-drive mechanism in an engine starter motor. The clutch mechanism is expected to accelerate the inertial mass of the flywheel of the engine as well as the engine-associated drive components. The resilient coupling, constituting an intermediate energy storage arrangement, is essential to avoid the destruction of the interfacing components between the clutch and the load. The stored rotational energy is released, to supplement the continuous energy maintainable by the electric motor, during initial acceleration of the load. In a similar manner the flywheel in the clutch, helps to smooth over the fluctuations in the dynamic frictional drag and thus reduces the necessary power of the motor, producing a more consistent level of output energy.

The invention also provides a drive system for moving a load subject to static and dynamic frictional drag, comprising an actuator of the form described immediately above, whose output pinion is coupled to drive the load, the flywheel being such that its rotational inertia at the speed of engagement of the centrifugal clutch is sufficient, in normal use, to overcome the static frictional drag of the load by the impulse of the engagement of the clutch with the load.

Further, the invention provides a method of driving a load subject to static and dynamic frictional drag, using an actuator of the type described above, comprising accelerating the electric motor of driving a load subject to static and dynamic frictional drag, using an actuator comprising accelerating the electric motor and flywheel so that the centrifugal clutch engages at a predetermined speed at which the rotational inertia of the flywheel is conveyed impulsively to the load to overcome the static friction; and maintaining electric motor drive to accelerate the load against its dynamic frictional drive.

Electric actuators may be used to move a load between end stops, and when the actuator reaches the dead end it experiences a backlash, which can be damaging and noisy. Accordingly, a further invention provides an actuator comprising an electric motor coupled through reduction gearing to an output coupling gear, the reduction gearing comprising a gear having two coaxial components with respective teeth meshing with corresponding driving and driven gears, the two components being drivingly coupled through a viscous damping member for absorbing shock and reducing backlash when the actuator hits a dead end in use.

The viscous damping member may comprise a solid element such as a disc between the two components of the gear.

This actuator may be of the type described above, with the centrifugal clutch and reduction gearing.

In order that the invention may be better understood, a preferred embodiment will now be described, by way of example only, with reference to the accompanying drawings, in which:

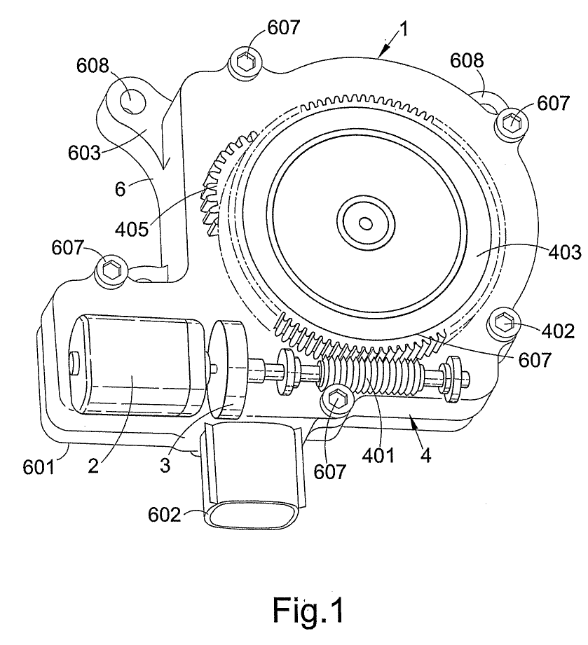

FIG. 1 is a perspective view from above of a car window actuator embodying the present invention, in which the housing is partially transparent to show the interior;

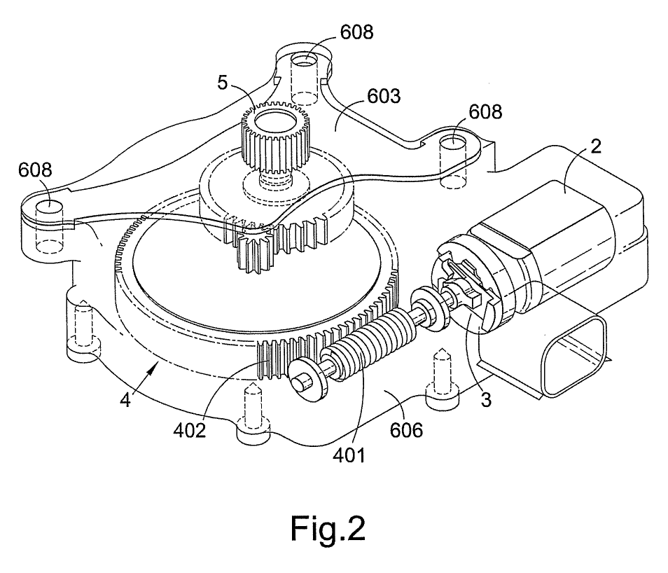

FIG. 2 is a perspective view from below corresponding to FIG. 1;

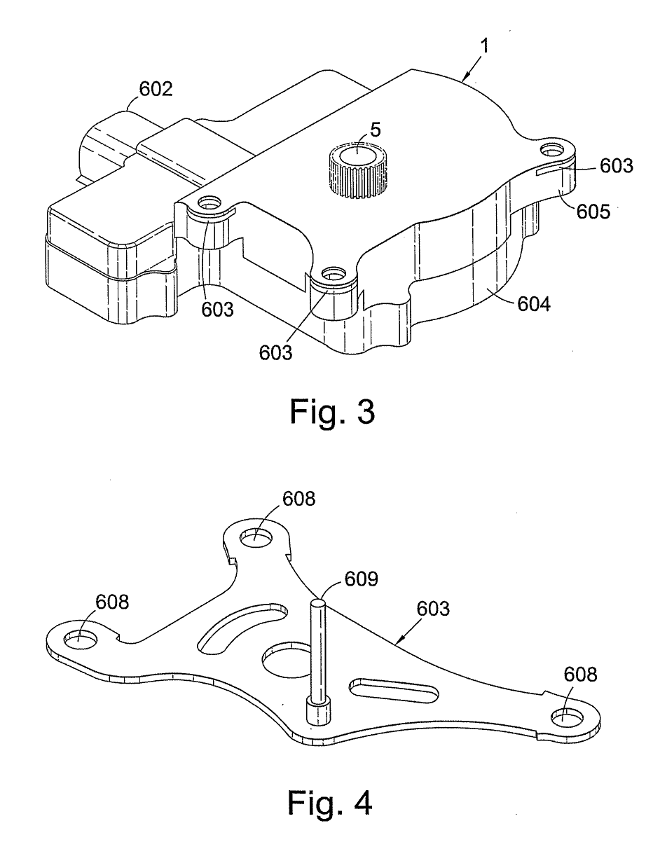

FIG. 3 is a perspective view from below of the actuator of FIGS. 1 and 2, with the housing shown solid;

FIG. 4 is a perspective view of a retention insert forming part of the housing of the actuator of FIGS. 1 to 3;

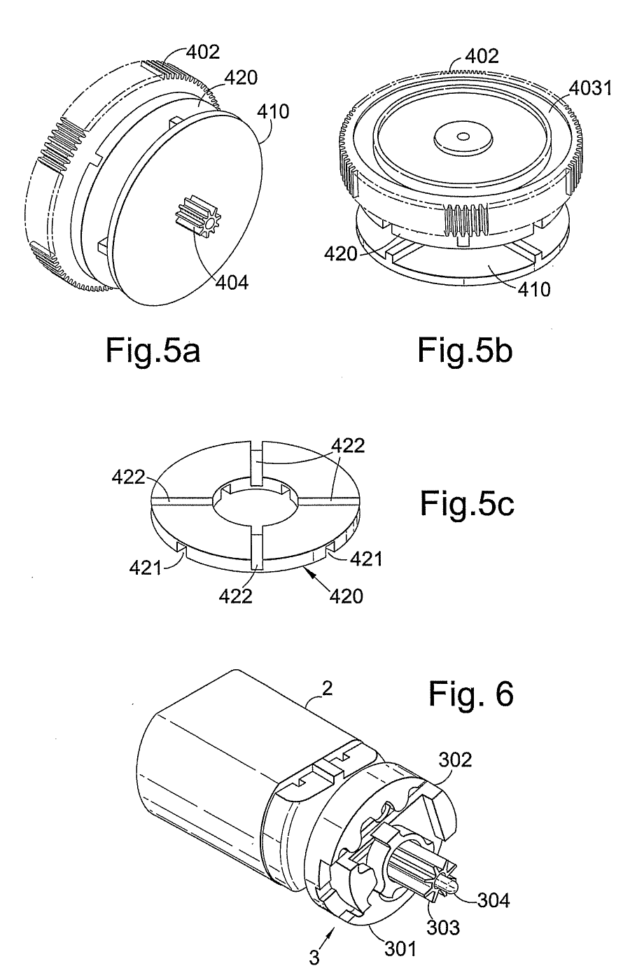

FIGS. 5a and 5b are exploded perspective views of a worm gear in the actuator of FIGS. 1 to 3, and FIG. 5c is a perspective view of a rubber damper disc in that worm gear;

FIG. 6 is an enlarged perspective view of an electric motor and flywheel and centrifugal clutch arrangement embodying the invention, similar to the arrangement shown in FIGS. 1 and 2;

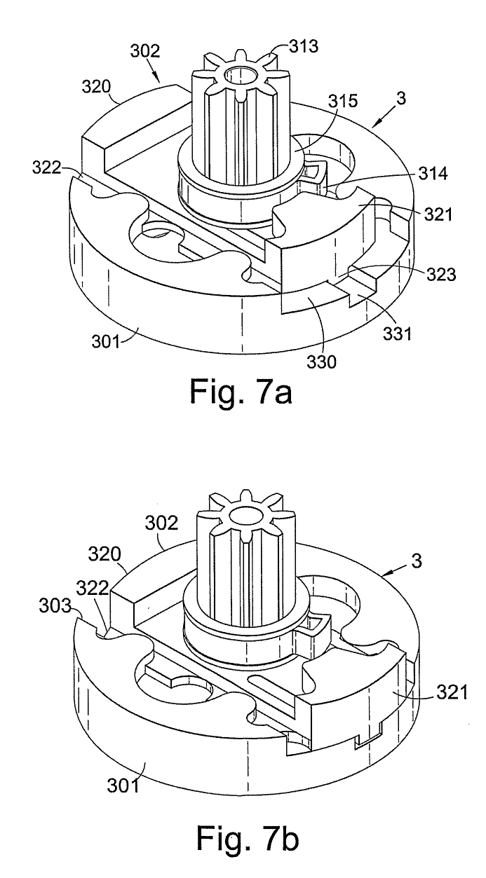

FIGS. 7a and 7b are perspective views from the downstream side of a centrifugal clutch embodying the invention, shown respectively in its engaged and its disengaged configuration;

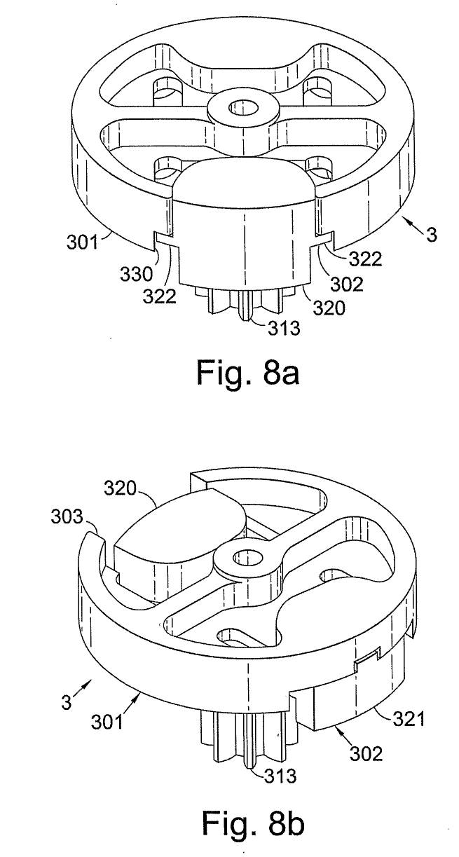

FIGS. 8a and 8b are perspective views from the upstream side corresponding to FIGS. 7a and 7b respectively;

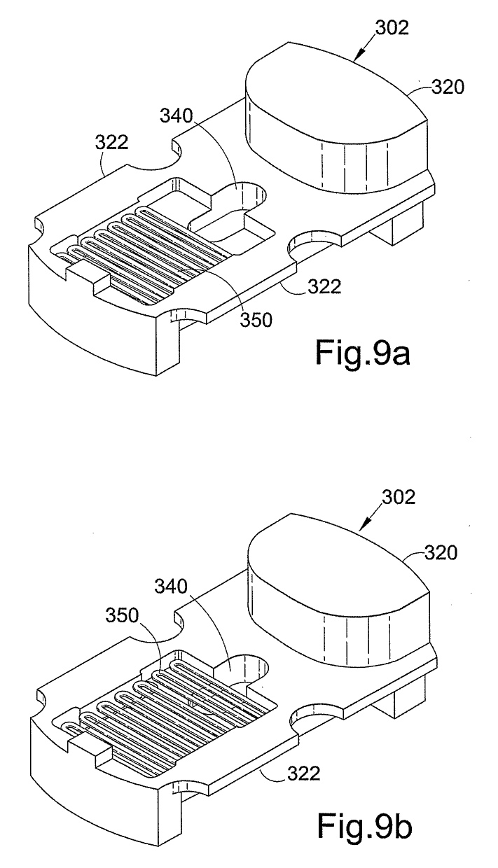

FIGS. 9a and 9b are perspective views from the upstream side of a centrifugal slider of the centrifugal clutch of FIGS. 7 and 8, showing respectively in its engaged and its disengaged configuration;

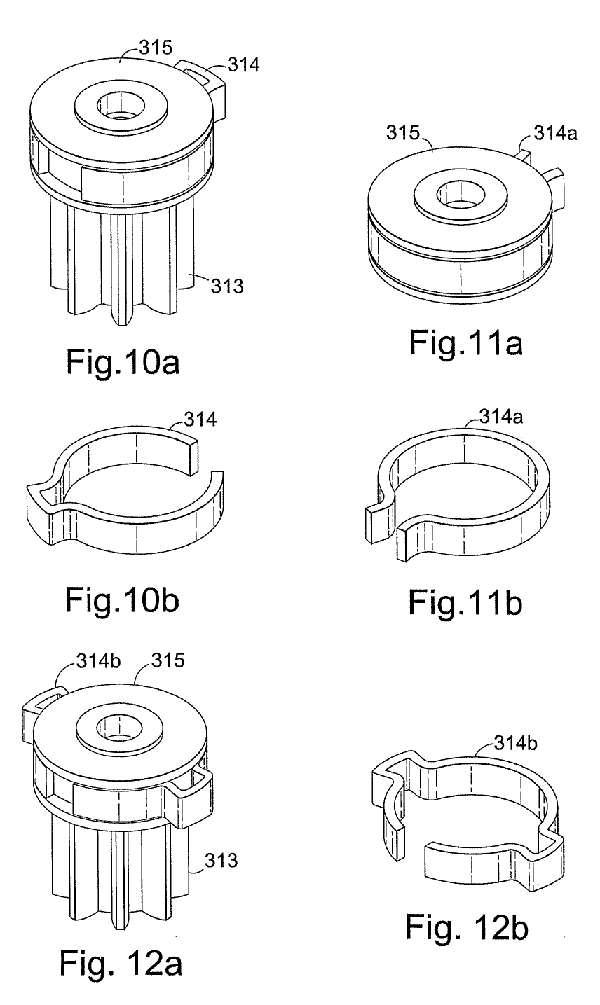

FIG. 10a is a perspective view of an alternative form of output drive dog in a centrifugal clutch embodying the invention, with FIG. 10b showing the drive dog component by itself;

FIG. 11a is a perspective view of an alternative form of output drive dog, with FIG. 11b showing a spring component of that drive dog by itself;

FIG. 12a shows a further alternative form of output drive dog, with FIG. 12b showing the sprung component of that drive dog; and

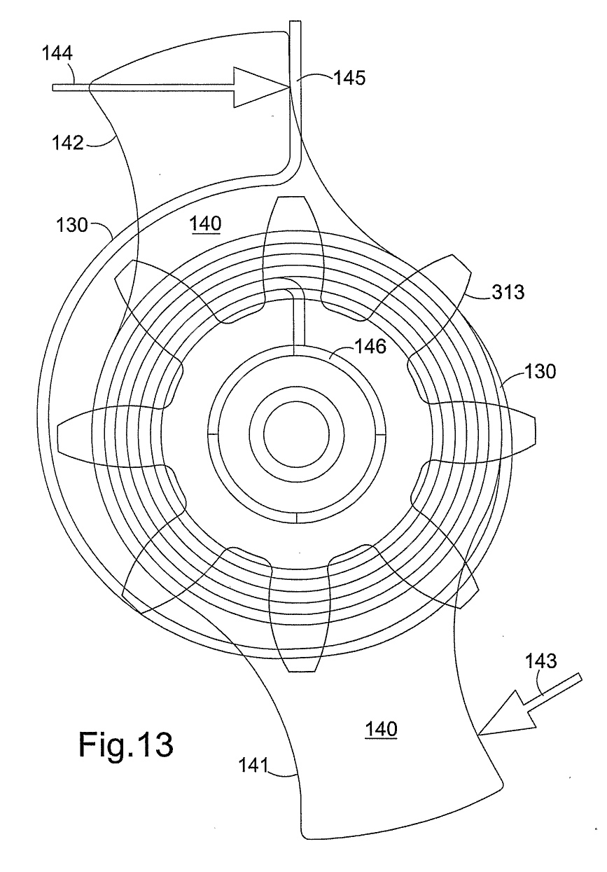

FIG. 13 shows a starter motor embodying the invention, with a farther alternative form of output drive dog, including a spring.

As shown in FIGS. 1 to 4, an electric actuator 1 for the window winding mechanism of a car comprises an electric motor 2 drivingly coupled to an integral flywheel and centrifugal clutch arrangement 3 driving a reduction gearing 4 whose output coupling gear 5 is arranged to drive a conventional window winding arrangement (not shown). These components are located within a housing 6 which in this example comprises mating shells 604, 605 sealed by means of an o ring seal 606. The two mating shells 604, 605 are held together by screws 607. The housing is of a glass-filled plastics material, with a steel retention insert plate 603, shown separately in FIG. 4, which confers particular rigidity to the structure. Three limbs of the retention insert 603 are formed with openings 608 which cooperate with corresponding formations in the housing to allow the entire actuator assembly to be mounted at three points in the vehicle. A spindle 609 formed integrally with the retention insert 603 supports the output coupling gear 5.

Electrical wiring connections from the exterior enter through a port 602 in the housing, with appropriate sealing. These wires supply current to the electric motor 2 and communicate with electronic sensors (not shown), such as Hall effect sensors or reed switches, adjacent a magnetic ring 403 on a worm gear 402, as described below.

An output drive dog of the centrifugal clutch 3 is coaxial with the electric motor drive spindle and with the flywheel arrangement 3, and drives a worm gear 401 with which it is coaxial. The electric motor 2, flywheel and centrifugal clutch arrangement 3, and elongate worm gear 401, are formed coaxially along one edge of the housing 6. The cooperating worm gear 402 is mounted for rotation on a spindle at the centre of the housing, normal to the axis of the motor 2. This gear 402 is the single largest component of the actuator, and the housing is accordingly made generally flat and rectangular.

As shown in FIGS. 5a, 5b and 5c, the large worm gear 402 has a circular channel 4031 which holds a ring magnet 403, for position sensing. 72 magnets are disposed equi-angularly around the ring 403, so that they comprise 144 poles spread over 360 degrees. Hall effect sensors mounted on the housing above the ring 403 are used to detect the passage of the poles, and external control circuitry (not shown) receiving electronic signals from the Hall effect sensors are used to determine the speed and direction of rotation of the gear 402. The torque developed by the actuator is a function of the speed, which function is predetermined and stored in the electronic control circuitry, so that torque can be controlled, for example for limiting output torque for anti-pinch safety reasons. Since the position of the gear may be determined, the position of the window may be determined.

The large worm gear 402 has three components apart from the magnet ring, as shown in FIGS. 5a and 5b. These components face each other coaxially. A driving component 402 has external teeth which mesh with the elongate worm gear 401. A driven helical spur pinion 404 is formed on a driven plate 410, and a rubber viscous damping disc 420 is held between the components 402 and 410 to provide resiliently deformable, viscous damping between them, to minimise backlash when the actuator hits dead end. The rubber material is, in this example, synthetic rubber with a Shore of A90 of compressibility, i.e. about 50 D; it may be “Hytrel” or “Santoprene” (Registered Trade Marks). The rubber disc 420, in this example, consists of eight equal 45° sectors divided by notches, four of the notches 421 being on one side and the other four of the notches 422 being on the opposite side. These notches engage over corresponding radial ribs formed on the inner surfaces of the gear components 402 and 410. Thus the ribs compress or squeeze the individual sectors of the rubber disc 420, when there is relative rotational movement of the components 402 and 410. There could of course be a different number of sectors, such as 90° sectors, this being a matter of appropriate design. There could be just one resilient block.

The helical spur pinion 404 drives a helical spur gear 405 which is coaxial with and connected rigidly to the output pinion 5, sharing the spindle 609. As shown in FIG. 2, large worm gear 402 is mounted for rotation between the retention insert 603 and the opposite housing shell 604.

The material and rigid structure of the housing and its internal components are selected to optimise the smoothness of the operation of the actuator, and to minimise its acoustic output. The rubber damping, as well as minimising backlash, also serves to isolate the vibrations of the electric motor from those of the window. However, the resilient deformability of the rubber disc 420 is not such as to undermine the “kick” i.e. the impulsive drive provided by the actuator at the point of engagement of the centrifugal clutch, as this is important in the overcoming of static friction in the load.

As shown most clearly in FIG. 3 the steel insert 603 has the additional effect of separating layers of the structure. We have found that the “sandwiching” of the layers of the assembly in this way has a beneficial acoustic effect, in that the interfaces between the layers tend to break up noise transmission across the structure. Vibrational noise is more readily absorbed at these planar interfaces, between the steel insert 603 and the mating shells 604, 605 of the housing. It is significant that the shells 604, 605 are of a different elasticity from that of the steel insert 603.

The electric motor 2 is shown together with the integral flywheel and centrifugal clutch arrangement 3 in FIG. 6. The flywheel and clutch arrangement 3 is disc shaped i.e. essentially cylindrical, formed coaxially over the motor drive spindle 304 and coaxially with an output drive dog 303. A disc shaped frame 301 has a channel across its diameter within which slides a centrifugal slider 302 which has massive enlargements at each end, and which is resiliently biased towards a disengaging position by means of a zig-zag compression spring 350 shown in FIGS. 9a and 9b respectively at its engaged and its disengaged position. As described in GB-A-2392958, the spring 350 is wholly recessed within the centrifugal slider 320, and one end of the spring bears against the motor spindle through an aperture 340 at the centre of the slider.

In the example shown in FIG. 6, the driven component of the centrifugal clutch is a drive dog 303 mounted coaxially on the motor spindle 304, the dog having three equi-angularly spaced teeth. In the alternative example shown in FIGS. 7 and 8, the drive dog 313 has a single tooth 314 mounted on a disc 315 formed integrally with a toothed cog 313. The driven component of the centrifugal clutch is configured to couple drive to the reduction gearing required in the specific embodiment, and in the case of the embodiment of FIGS. 1 and 2 the drive dog 314 is connected directly to the elongate worm gear 401, rather than by way of any toothed gear 313.

As shown most clearly in FIGS. 7 to 9, the centrifugal slider 302 is constrained by rails to slide across a channel formed diametrically across the cylindrical driving component 301. This channel 330 is formed with a central axial groove 331 which guides a complementary projecting land 323 formed along the centre line of the centrifugal slider 320. Rails 323 projecting along each side edge of the centrifugal slider 320 are guided between corresponding formations along the edge of the channel 330 in the cylindrical base portion 301.

The centrifugal slider 320 has a massive enlargement 320 at one end, which acts as a bell weight pulling the slider towards the engaged position, shown in FIGS. 7a and 8a, from its disengaged position shown in FIGS. 7b and 8b, against the force of the compression spring 350. At its engaged position, the massive enlargement 320 has a part-cylindrical outer surface which is flush with the outer cylindrical surface of the base portion 301, and the enlargement 320 complements a rim of the base portion 301. The rim has an opening 303 corresponding to the width of the channel 330, into which the massive enlargement 320 slides, in effect closing the gap when it reaches the engaged position. At this engaged position, the centrifugal slider 302 reaches a radial end stop, and its engagement dog 321 engages the drive dog 314. At this point of engagement, the driving and driven components of the clutch lock together, to convey rotational drive to the dog 313.

At the opposite end of the centrifugal slider 302 there is a further massive enlargement integral with the dog 321, and at the fully disengaged position of the clutch, shown in FIGS. 7b and 8b, this rests in a gap in the rim of the cylindrical base 301, with its outer part-cylindrical surface flush with the cylindrical surface of the rim. At this point also, the centrifugal slider 302 is abutting against an end stop.

The rotational speed at which the clutch engages is pre-selected by the configuration of the clutch components and the spring strength of the compression spring 350.

It is an important element of the invention that the clutch constitutes a flywheel, capable of accumulating rotational energy as the clutch is accelerated to its engaged position. The major components of the flywheel are the massive rim of the cylindrical base portion 301, and the complementary massive enlargements 320, 321 of the centrifugal slider 302. This allows motors to be used with very light-weight rotors.

The massive enlargements 320, 301 are disposed precisely so that the centre of inertia of the combined clutch arrangement 3 is located on its axis of rotation, i.e. the motor spindle, when the clutch is fully engaged as shown in FIGS. 7a and 8a. At other positions of the centrifugal slider 302, the centre of inertia is translated along the diameter of the rail 331, to an off axis position. The importance of this arrangement is that once the clutch is engaged and the electric motor is driving the load, the clutch is perfectly balanced rotationally, to minimise noise and stress. During its acceleration from rest to the engaged position, it is less important for the clutch to be rotationally balanced, as it is not under load.

Alternative configurations for the output drive dog of the centrifugal clutch are shown in FIGS. 10 to 13. FIGS. 10a and 10b show the drive dog of FIGS. 7 and 8. The pinion 313 is connected to an abutment cap 314, 315, and these may be formed as two units or else as one cold formed unit or moulded unit. The dog tooth is formed as a central portion of a spring 314, which is retained around a groove of the cap 315. Frictional engagement over the cylindrical interface between the spring 314 and the groove of the cap 315 conveys output drive rotationally from the driving to the driven components of the clutch. The friction is sufficiently strong that relative rotational movement is resisted unless there is a fault condition in the drive of the actuator or it reaches an end stop. This damper spring arrangement allows for slippage, to prevent undue wear or damage. The friction is sufficiently strong that the clutch is still able to develop a strong “kick” or impulsive force, to overcome static friction in the load being driven by the actuator.

In the alternative arrangement shown in FIGS. 11a and 11b, the cap 315 has the same shape, but the spring 314a has outwardly turned ends and is otherwise cylindrical; the ends of the spring, rather than the centre of the spring form the dog tooth. Upon engagement, the spring 314a tends to be compressed, increasing its frictional grip around the cap 315.

A further alternative arrangement is shown in FIGS. 12a and 12b, in which a lozenge-shaped spring 314b constitutes two teeth at opposite diametric positions, and the spring has an opening on one side to allow it to be positioned over the cap 315 within the groove. The advantage of having two teeth is that they are balanced rotationally.

Instead of allowing frictional slippage, the arrangement of FIG. 13 allows relative rotary movement against a resilient bias, storing potential energy in a torsion coil spring 130. The spring functions in the same way as a clock spring, storing energy for subsequent controlled release. It may in this example be about 10 mm wide and 0.5 mm thick, capable of delivering 10 kW output as it unwinds. Thus the output drive member of the clutch has a coupling member in the form of a gear 313, for driving a load such as a vehicle engine. It also has a dog 140 with a pair of diametrically opposed teeth 141, 142, either of which may engage the centrifugal slider.

As shown in FIG. 13, tooth 141 engages the slider to produce a force represented by arrow 143. The dog 140 is connected at tooth 142 to one end 145 of the torsion spring 130 whose other end 146 is connected to the gear 313. The tooth 142 drives the spring 313 as shown by arrow 144.

This arrangement allows the rotational inertia of the flywheel to be transferred impulsively, over a period of time, to the load, by the intermediate storage of potential energy in the torsion spring 313. The delivery of torque from the flywheel to the load is thus smoothed over time, reducing the level of torque of the impulsive “kick” whilst substantially maintaining the total impulse represented as the time integral of torque: ∫Idt.

The starter motor comprises an electric motor and flywheel similar in principle to those of FIGS. 6-9, but with a greater power than is necessary for a window winding mechanism. The flywheel has the output arrangement of FIG. 13. The output gear (normally referred to as the drive pinion) is coupled to the flywheel of the engine. The flywheel is preferably adapted with a gear to mesh with the drive pinion of the starter motor (a typical gear ratio is 20:1).

The starter motor is essential for initial engine rotation. Due to the considerable static and dynamic friction of the engine assembly, the starter motor requires a substantial intake of electrical power from the battery to enable movement of the engine components, crankshaft, engine flywheel and pistons. The starter motor uses the electrical energy stored in the battery to rotate the flywheel, which is bolted to one end of the crankshaft. The rotating flywheel enables piston movement which subsequently functions independently from the starter motor.

By way of example, a car with a 1200 cc engine has a starter motor weighing 3 or 4 kg which draws up to 350 A in-rush current and weighs 3.7 kg; providing a run torque of 0.25 kg.m at 9 v and 155 A when the engine is turning at a free-running speed of 2100 rpm; its maximum power is 0.8 kW, and its locking torque is 0.56 kg.m. With the benefit of the invention, the same car can be started with a starter motor weighing only 1.2 kg, in which the flywheel weighs 300 g and the motor 600 g; with a torsion spring which is 10 mm wide and 0.5 mm thick which can develop 10 kW, it may deliver 10 or 12 Nm torque immediately after the in-rush current to the electric motor, dropping to 4 or 5 Nm steady torque. The motor may consume nominally 9 A with a maximum of 36 A at 12 v. Whereas a conventional car may require a battery with a capacity of 20 Amp.hours, it would be sufficient to use a 5 or 6 Amp.hour battery. The savings in weight of the starter motor and the battery are clearly significant.

In the example of a truck starter motor, the weight of the starter motor may be reduced from 35 kg to less than one third of this. The percentage reduction in current requirements is comparable to that achieved in the starter motors for cars, so lighter weight batteries may be used in trucks also.

The operation of the actuator will now be described. It will be understood that the various alternative components shown in the drawings may be substituted for corresponding components of FIGS. 1 to 3. Further, the specific reduction gearing arrangement shown in FIGS. 1 to 3 is not essential, and many different arrangements are possible, with two steps, as in this example, or a different number of steps.

When a car window is required to be wound up or down, a corresponding switch is operated which in turn controls the electronic control unit centrally which controls electric power sent to the actuator of FIGS. 1 and 2. The electronic control unit also stores information as to the position of the window, using the control signals from the sensors within the actuator 1, derived from the Hall-effect sensors over the magnetic disc 403. A similar position-sensing arrangement is disclosed in my patent application WO 03/004810 and GB-A-2381034.

Electric power drives the electric motor 2 until the position feedback sensing arrangement has determined that the window has reached a desired position; or until a fault condition is sent, for example a pinch condition, when electric drive is immediately terminated.

When electric power is supplied to the electric motor 2, the flywheel and clutch arrangement accelerates until it reaches the speed at which the clutch engages. Upon engagement, the rotational energy is conveyed in part to the reduction gearing and thus to the load as a substantial “kick” or impulse. This has the advantage of overcoming static friction inherent in the load, for example due to friction in the window frame drive levers and the edges of the window glass within the weather-proofing door structure. Continued motion of the clutch begins to accelerate the load. The electric motor continues to accelerate until it reaches its maximum power at which point the load continues moving at constant speed. The electronic control unit monitors the position of the load and terminates power once the load, in this case the window, has reached the desired position, or slightly before it reaches that position, in anticipation of the run on effect. If there is excessive resistance from the load, then the load will decelerate the clutch and cause it to disengage, such that continued power to the electric motor causes the clutch once again to engage and provide a further impulsive force. Should it be necessary, therefore, a series of impulses is provided in quick succession to the load, overcoming friction.

The amount of rotational energy stored in the flywheel, and hence the strength of the impulsive force upon engagement, is predetermined by selecting the spring force in the clutch, but may also be determined by appropriate selection of the flywheel mass, its distance from the centre of rotation, the power and speed of the motor (by voltage or current rating selection), and by the rate of acceleration of the motor. The actuator may be designed for a very large variety of different applications, as described above. Whilst the use of a worm gear set as shown in FIGS. 1 and 2 is useful for driving a car window, in that its very high mechanical advantage provides a useful resistance to the weight of the window, resisting reverse motion by friction in the reduction gearing, it is not essential to use worm gears.

For some applications, it will be useful to provide a pulsed drive, for example in steps of 1 mm or 100 mm. Depending on the gear ratios, the actuator may be used to lift weights of just one grain or weights of 300 kg in an elevator, and the speed may be controlled by appropriate feedback mechanisms.

The damping arrangement in the gears, for example from the rubber block 420 of FIG. 5, reduces the undesirable effects of backlash, when the drive hits dead end. The rubber block or blocks also absorb noise from the gearing.

The damper spring arrangement in the drive dog of the centrifugal clutch provides for safety overload, as described, but it also has the advantage of damping the spindle vibrations from the motor. As described, the dog could have any number of teeth, i.e. three as shown in FIG. 6, or one as shown in FIG. 7 or two as shown in FIG. 12, or any other number. Having plural teeth spaced equi-angularly provides good rotational balance, minimising vibration when the whole assembly is being driven.

Additionally, the drive dog can be arranged with resilient damping in a similar manner to the large gear 402 in the window winder mechanism, by sandwiching a rubber damper or other elastic material between the drive dog and the driven part in parallel or coaxial with the shaft of the motor. This drive dog damping can be in lieu of or in addition to the resilient damping of the large gear 402.

In this example, the housing is sealed with a rubber seal and screws, but alternatively it could be welded ultrasonically, for example, to provide water resistance, to the international standard IP67.

To illustrate the advantage of the invention over a conventional window actuator, it is instructive to compare the motor ratings for equivalent systems. A conventional car window actuator has a motor with a typical stall current of 36 amps, nominally 9 amps at 12 volts, operating at 10% efficiency to deliver about 10 watts. It develops a continuous torque of 1 Nm, with a breakaway torque of 12 Nm. With the benefit of the invention, a much smaller motor may be used, with a rating of 2.8 amps, still delivering a stall torque of 15 Nm and a continuous torque of 6 Nm. The conventional actuator has no clutch and has no flywheel stored energy effect.

With the use of the invention, it is possible to reduce very substantially the size and weight of the actuator. For a window actuator, for example, the weight of the motor may be reduced from 640 g to just 40 g, and the entire actuator assembly including the motor may be reduced from typically 740 g to 200 g. The volume is more than halved, and the cost and energy consumption are reduced very substantially. The use of a small motor makes the actuator much quieter, and the damping mechanisms in the clutch and the reduction gearing contribute to noise reduction. The necessary rigidity in the structure is achieved with the use of the steel insert, allowing for the remainder of the housing to be of lighter weight glass filled plastics material.

The use of the invention in an automotive starter motor will now be described. As mentioned above, starter motors have substantial inertia, being coupled to the engines, and there is a heavy dynamic frictional drag at low speed, during initial acceleration. It is necessary to spread the applied torque over time, by the intermediate storage of rotational energy in the torsion spring 130. When the car ignition switch is activated, a relay connects the electric motor 2 to the car battery, and the clutch flywheel accelerates and then engages. This drives the spring 130 and the spring 130 drives the gear 313 to crank the engine. As the spring first coils up and then unwinds, torque is conveyed steadily to the gear 313, using up energy stored in the flywheel. Continued power supplied to the motor 2 maintains drive to the gear 313 to accelerate the engine further and then, once it has reached constant speed at the maximum power of the electric motor 2, to keep the engine turning until it fires, at which point the clutch over-runs and the electric motor may be switched off.

For a myriad of other applications of the invention, the electric motor and the clutch-flywheel could be used directly on the load without the need for any gearing systems. One example is the use of the actuator in place of a pneumatic drive for a pneumatic drill, of the type used for digging road surfaces for example. A drive dog rotated by the electric motor and clutch-flywheel is arranged to engage periodically the drill bit assembly of an otherwise conventional drill. This ‘kick drive’ through the drive dog lifts the drill bit impulsively and then allows it to drop onto the surface being drilled, and the cycle is repeated with the next rotational engagement of the dog. Alternatively, the kick drive may impact downwardly on the drill bit, to drive the bit into the drilled surface, which then provides an impulsive reaction force to bounce the drill bit upwardly, allowing the cycle to repeat, with percussive drilling effect. Thus the drive dog may be coupled directly to the bit assembly, or else through a spring linking the bit to a drill frame. This hammer effect may be applied in other tools such as hammer drills, and may be for hand-held tools or for large industrial tools and machine tools

1. An actuator comprising an electric motor with a drive shaft drivingly coupled to an output coupling gear at rotary speeds above a predetermined threshold, by way of a centrifugal clutch, the centrifugal clutch comprising:
a centrifugal slider with a massive enlargement at one end and a first coupling formation;
a frame formed to carry the centrifugal slider on formations to constrain it to sliding motion between an extended radial position and a retracted radial position, and to fit fixedly on the drive shaft to be driven by it, with the shaft at right-angles to the axis of sliding motion of the frame;
a second coupling formation mounted for rotation on the drift shaft, and which connects drivingly with the first coupling formation only when the centrifugal slider is at its extended position;
and means for biasing the centrifugal slider towards its retracted position;
whereby rotation of the centrifugal slider and frame causes the massive enlargement to pull the centrifugal slider radially from its retracted to its extended radial position to cause the first and second coupling arrangements to interengage and thus to transmit rotary drive from the drive shaft to the output coupling gear, but the biasing means causes disengagement when the rotation ceases, so as to decouple the drive shaft from the output coupling gear;
the frame and the slider constituting a flywheel for accumulating rotational inertia during acceleration to the speed at which the centrifugal clutch engages the electric motor with the output coupling gear;
in which the second coupling formation is coupled rotationally to drive the output coupling gear such that limited relative rotational movement is allowed between them;
and in which the output coupling gear is coupled resiliently to the second coupling formation so that an applied torque causes proportionate relative rotational movement which is then reversed by spring action when the applied torque is reduced.

2. An actuator clutch according to claim 1, comprising a torsion spring connecting the output coupling gear drivingly with the second coupling formation.

3. An actuator according to claim 1, comprising reduction gearing between the centrifugal clutch and the output coupling gear.

4. An actuator according to claim 3, comprising a housing accommodating the electric motor, the flywheel and the centrifugal clutch all coaxially along one edge and further accommodating the reduction gearing.

5. An actuator according to claim 3, in which the reduction gearing comprises sensors for providing electrical signals indicative of the motion of the reduction gearing.

6. An actuator according to claim 5, comprising permanent magnets on a gear of the reduction gearing cooperating with fixed sensors responsive to the passage of the permanent magnets to generate the electrical signals.

7. An actuator according to claim 3, in which the reduction gearing comprises a worm coaxial with the centrifugal clutch.

8. An actuator according to claim 1, in which the center of inertia of the centrifugal clutch is axial only when the centrifugal slider is at its extended radial position, whereby its rotation is fully balanced when the clutch is engaged.

9. An actuator according to claim 8, in which the massive enlargement slides radially into a tangential gap in a rim portion of the frame.

10. An actuator according to claim 9, in which the centrifugal slider has a further massive enlargement at the opposite end from the said one end, which slides radially into another tangential gap in the rim portion of the frame.

11. An actuator according to claim 1, in which the slider is carried wholly within the frame.

12. An actuator according to claim 11, in which the slider has an outer flat surface flush with one major surface of the frame normal to the drive shaft axis.

13. An actuator according to claim 1, in which the flywheel is generally disc-shaped.

14. An actuator according claim 13, in which the frame is generally cylindrical with an elongate channel across its diameter which accommodates the centrifugal slider, the channel having guides cooperating with edges of the centrifugal slider.

15. A starter motor comprising an actuator according to claim 1, in which the resilient coupling between the output coupling gear and the second coupling formation is arranged to store rotational energy once the clutch has engaged, and to release the stored energy to crank an engine to which the starter motor is coupled, in use.

16. A drive system for moving a load subject to static and dynamic frictional drag, comprising an actuator according to claim 1 whose output coupling gear is coupled to drive the load, the flywheel being such that its rotational inertia at the speed of engagement of the centrifugal clutch is sufficient, in normal use, to overcome the static frictional drag of the load by the impulse of the engagement of the clutch with the load.

17. A drive system according to claim 16, in which the load is a window, comprising a window drive frame drivingly coupled to the actuator, such that the rotational inertia stored in the flywheel is transferred impulsively to the window drive frame, to overcome static friction in the sliding motion of the window in use, when the centrifugal clutch engages.

18. A drive system according to claim 16, in which the load is one of: a sun-roof, a seat and a door or other closure, the arrangement being such that the rotational inertia stored in the flywheel is transferred impulsively to the sun-roof, the seat or the door or other closure, to overcome static friction in its motion in use, when the centrifugal clutch engages.

19. An automotive steering lock comprising an actuator arranged to lock or unlock the steering column, the actuator being in accordance with claim 1.

20. A windscreen wiper drive system comprising an actuator according to claim 1 coupled for driving the windscreen wiper.

21. An electronic parking brake comprising an actuator according to claim 1 coupled for driving the brake.

22. A seat belt pretensioner with a rotary drive coupled to be driven by an actuator according to any of claim 1.

23. An automotive transmission in which gear change is effected by an actuator according to claim 1, coupled for effecting gear change.

24. A method of driving a load subject to static and dynamic frictional drag, using an actuator according to any of claim 1, comprising accelerating the electric motor and flywheel so that the centrifugal clutch engages at a predetermined speed at which the rotational inertia of the flywheel is conveyed impulsively to the load to overcome the static friction; and maintaining electric motor drive to accelerate the load against its dynamic frictional drive.

25. A method according to claim 24, in which the load is a car seat, a sunroof, a window, a steering lock, a windscreen wiper, an automated manual transmission, a seat adjuster, an electronic parking brake or a seat belt pretensioner.

26. A method according to claim 24, comprising using the rotational inertia of the flywheel to apply torque to the second coupling formation to store energy in the resilient coupling between the output coupling gear and the second coupling formation, and to release the stored energy over a period of time by the output coupling gear driving the load; whereby the rotational inertia is conveyed impulsively to the load over the period of time to overcome static friction and to overcome dynamic friction during initial acceleration of the load.

27. A method according to claim 26, in which the actuator is a starter motor.

28-42. (canceled)
